(19) United States
(12) Patent Application Publication
(10) Pub. No.: US 2011/0273303 A1
(43) Pub. Date: Nov. 10, 2011

(54) System and Method to Collect Status Information From Light Based Indicator Systems Such as Stack Lights, Status Lights, Traffic Lights, Safety Lights

(75) Inventors: John Keever, Boca Raton, FL (US); Dennis Lunde, Boca Raton, FL (US)

(73) Assignee: ILS TECHNOLOGY LLC, Boca Raton, FL (US)

(21) Appl. No.: 13/101,551

(22) Filed: May 5, 2011

Related U.S. Application Data
(60) Provisional application No. 61/331,450, filed on May 5, 2010.

(51) Int. Cl. G08B 21/00; G01J 1/44

(52) U.S. Cl. 340/635; 250/214.1; 250/208.2

(57) ABSTRACT

A system and method for monitoring status information from a light based indicator system (e.g., stack lights, status lights, traffic lights or safety lights, etc.). At least one light sensor is positioned adjacent to an existing light indicator system, the existing light based indicator system having at least one indicator light to be monitored. A monitoring device at a location remote from the existing light based indicator system receives signals from the at least one light sensor indicative of a status of the at least one indicator light.

### CROSS-REFERENCE TO RELATED APPLICATIONS

This application claims the benefit of co-pending Provisional Patent Application Ser. No. 61/331,450 entitled “System and Method to Collect Statue Information from Light Based Indicator Systems Such as Stack Lights and Status Lights”, filed on May 5, 2010, the entire disclosure of which is incorporated by reference herein.

### FIELD OF THE INVENTION

The present invention is directed generally toward the monitoring of light indicator systems and, more particularly, toward the automatic monitoring of light indicator systems indicative of various conditions.

### BACKGROUND OF THE INVENTION

In many industries, equipment is initially installed and control and monitoring systems are integrated to this equipment and a production line is brought up. An example of a type of monitoring equipment is a stack light, which is generally used to indicate the operational status of a machine. The stack light could have one light to indicate the operational status of a machine (e.g., “on” and “off”), or could have a plurality of lights in different colors indicative of various conditions and/or operational status of the machine or system. The original purpose of the stack lights was to allow the operators on the floor to be able to visually determine the condition and/or operation status of a machine(s) or system(s) by viewing the stack lights. However, over time, as automation continued to develop, industry took to providing fewer operators on the plant floor. Thus, there developed a need to view this operational status data which typically was provided by the stack lights from many machines at a central location.

Additionally, over time, and after the production line is up and running, new requirements are often developed for indicators, parameters, conditions and other things/items that should be monitored to improve the overall system process. This includes, but is not limited to, viewing status data from a central location (as mentioned above) and/or adding additionally sensors also to be viewed from a central location. However, to change or modify the existing equipment to add the ability to monitor some new indicator/parameter/condition is a complex and costly process that typically requires an intrusive change to the system. To add a physical interface or make some other modification to a machine or system, the production line equipment typically has to be stopped or shut down, which disrupts normal production thus decreasing productivity. Additionally, the equipment warranty may also be voided by making changes or modifications to the existing system.

What is needed is a means to effectuate the addition of physical sensors in a non-intrusive manner that does not disrupt the current, typical production system. While there are sensor producers that do allow add on sensors to be added to existing equipment in parallel to the original control equipment, these sensors are generally used for only temperature, vibration and humidity. It is often desirable to monitor other parameters on a plant floor. In the case of many industrial plant floors, and also in certain civil engineering construction projects, the system status or machine condition/parameter status is often indicated by a light system. In general, there are no tools to provide a computer based system to gather information from these manual status lights.

The present invention is directed toward overcoming one or more of the above-identified problems.

### SUMMARY OF THE INVENTION

A system and method are disclosed for detecting, for example, the on/off condition of a light based indicator system, such as a factory stack light, for external monitoring of the lights. The data obtained is provided, for example, to a personal computer (“PC”) or a programmable logic controller (“PLC”) or to an embedded processor to be used for the plant operators or factory specialists to view from a central location. The central location is typically remote from the plant floor where the stack light is located. The obtained data can also be stored in a database and used for trending and/or in an application to send alerts of various conditions such as, for example, a fault or line-down condition. This data can be viewed remotely, either from a location in the plant or from a remote location, rather than requiring a plant employee to walk the plant floor. The disclosed system and method is directed toward an external system which does not interfere with the existing systems. While stack lights have been identified as a type of exemplary light based indicator system, the inventive system and method has a myriad of other alternate usages such as, for example, to verify the operation of traffic signals and/or railroad crossing signals and/or other safety signals, to ensure no bulbs are burnt out and that power is being supplied to the main safety or signaling light system.

In addition to use on plant floors, light sensing systems are commonly used in such applications as, for example:
Sensing ambient light to turn on/off exterior lighting.
Sensing ambient light to turn on/off car lights.
Sensing the disruption of a beam of light for safety reasons, such as, for example, with a garage door closing.
Sensing the disruption of a beam of light for setting off an audio alarm (e.g., intruder warning).
Sensing the disruption of a beam for indicating a part is on a conveyor.
Sensing infrared light to control TVs and other electronic products remotely.

While light sensing systems are common, they are typically designed where the light sensing is built into a product as part of its function. In the disclosed system and method, the light sensing is added to existing equipment after production or installation to provide a secondary function. The disclosed system and method also allows for tuning the sensitivity of the system to accommodate various situations such as, for example, low light factories or bright light traffic intersections.

In the case of plant floor tools, as previously noted, many are equipped with “stack lights” which indicate, typically with a stack of red, yellow, green and other color lights, the overall “health” of the tooling at each work station or at each tool or piece of equipment or system. These stack lights are monitored in a visual manner by the production personnel on the plant floor. In the case of traffic lights or railway crossing lights, the warning lights are used by drivers to understand the road status and whether to proceed or not. In each case, these light based systems were designed as visual indicators for feedback and action. With the disclosed system and method, the visual light information can be fed back to a parallel computer based tracking system by means of, for example, LED sensors. While there are light sensors available in the industry, they are generally used to detect a unit of work being present at a workstation or simply count items passing by them; they are neither used nor designed for the detection of status conditions of existing status indicator lights.

Rather than relying on a production supervisor or other personnel to physically walk the production floor and monitor the actual tools by viewing the stack lights, through use of the disclosed system and method, the stack light status can be automatically read and the data sent to a central location for monitoring. This is particularly advantageous in the case of harsh or dangerous production environments, where it is desirable to minimize the number of people in the environment. Centralizing the tool data also has the advantage of being able to develop standard responses to production problems. Further still, centralization is also useful when the equipment manufacturer wants to know a summary of tool reported behavior over time, as the monitored data can be saved and a trend of the status can be created and analyzed.

By analogy, rather than relying on a driver of an automobile to report the outage of a traffic signal or railway crossing signal, the external sensor(s) of the disclosed system and method can be used to relay light status to a central controller for review and scheduled repair if needed.

The disclosed system and method provides an external set of sensors that are configured to “attach” or mount adjacent to the indicator light system so that their on/off status, and/or color status, and/or bright/dim status can be monitored. This information is fed to a remote or other location for storage and/or review and analysis. In the case of production equipment, for example, this information can be sent to a central location for monitoring and trending. In the case of civil engineering systems, for example, the status of a traffic light or traffic signal or railway crossing light can be monitored and analyzed. For example, if the traffic light is never on, or if the railroad crossing signal indicator does not come on in a certain period of time (e.g., a 24 hour period), the system could determine that a bulb is bad in the system and appropriate action taken. The disclosed system and method is not limited to light based indicator systems, but can also be tied to other sensing systems to allow the user to create logic and events based on the multiple inputs.

In one embodiment, a system for monitoring status information from a light based indicator system (e.g., stack lights, status lights, traffic lights or safety lights, etc.) is disclosed, which includes at least one light sensor positioned adjacent to an existing light indicator system, the existing light based indicator system having at least one indicator light to be monitored, and a monitoring device at a location remote from the existing light based indicator system, the monitoring device receiving signals from the at least one light sensor indicative of a status of the at least one indicator light.

The monitoring device stores information regarding the status of the at least one indicator light in a database as status data and/or displays information regarding the status of the at least one indicator light on a display as status data. The monitoring device can include, for example, a personal computer (“PC”) or a programmable logic controller (“PLC”) or other similar devices.

In one form, the status of the at least one indicator light is indicative of a condition of a production system operatively connected to the light based indicator system. The monitoring device monitors conditions of the production system via the status of the at least one indicator light.

In another form, the disclosed system further includes a signal conditioning device receiving the signals from the at least one light sensor indicative of the status of the at least one indicator light and converting the received signals into second signals which are understood by the monitoring device.

In one form the status of the at least one indicator light is “on” or “off”. However, the status of the at least one indicator light could also be based on how brightly or dimly lit the at least one status indicator light is, depending upon the desired application.

The status of the at least one indicator light is provided as an input to business logic, alone or in combination with other sensor data, to trigger events and/or alerts. The events and alerts may be sent to the plant floor operator and/or the original equipment manufacturer.

In a further form, the disclosed system includes an ambient light sensor positioned in proximity to the at least one light sensor, and a compensation circuit receiving (a) signals from the ambient light sensor indicative of ambient light conditions, and (b) signals from the at least one light sensor indicative of the status of the at least one indicator light, wherein the compensation circuit conditions the at least one light sensor signals based on the ambient light sensor signals to compensate for ambient light conditions.

The at least one light sensor may be movably attached to a base member mountable adjacent to the existing light based indicator system.

In another embodiment, a system for monitoring status information from a light based indicator system (e.g., stack lights, status lights, traffic lights or safety lights, etc.) having a plurality of indicator lights to be monitored is disclosed, which includes a plurality of light sensors positioned adjacent the plurality of indicator lights, the plurality of light sensors outputting signals indicative of a status of each of the plurality of indicator lights, wherein the status of each of the plurality of indicator lights is indicative of various conditions of an operational system to which the light based indicator system is operatively connected, and a monitoring device at a location remote from operational system and the existing light based indicator system, the monitoring device receiving the output signals from the plurality of light sensors and monitoring the various conditions of the operational system via the status of each of the plurality of indicator lights.

The monitoring device stores information regarding the various monitored conditions of the operational system in a database for analyzing and trending, and/or displays information regarding the various monitored conditions of the operational system on a display for viewing and action by personnel. The monitoring device may be, for example, a personal computer (“PC”) or a programmable logic controller (“PLC”) or other similar device.

In one form the disclosed system further includes a signal conditioning device receiving the output signals from the plurality of light sensors and converting the received signals into second signals which are understood by the monitoring device.

In a further form, the disclosed system further includes at least one ambient light sensor positioned in proximity to the plurality of light sensors, and a compensation circuit receiving (a) signals from the at least one ambient light sensor indicative of ambient light conditions, and (b) the output signals from the plurality of light sensors, wherein the compensation circuit conditions the output signals from the plurality of light sensors based on the ambient light sensor signals to compensate for ambient light conditions.

The status of the at least one indicator light may be “on” or “off”. However, the status of the at least one indicator light could also be based on how brightly or dimly lit the at least one status indicator light is, depending upon the desired application.

In one form, the plurality of light sensors are movably attached to a base member mountable adjacent to the existing light based indicator system. In this manner, the plurality of light sensors may be positioned to accurately sense the status of an associated indicator light. The plurality of light sensors may be provided in a one-to-one relationship with the plurality of indicator lights, such that one light sensor monitors the status of one indicator light.

A method of monitoring status information from a light based indicator system (e.g., stack lights, status lights, traffic lights or safety lights, etc.) having a plurality of indicator lights to be monitored is also disclosed. The method includes the steps of providing a plurality of light sensors positioned adjacent the plurality of indicator lights, the plurality of light sensors outputting signals indicative of a status of each of the plurality of indicator lights, wherein the status of each of the plurality of indicator lights is indicative of various conditions of an operational system to which the light based indicator system is operatively connected, transmitting the output signals from the plurality of light sensors to a monitoring device at a location remote from operational system and the existing light based indicator system, and monitoring the various conditions of the operational system via the status of each of the plurality of indicator lights at the remote location.

In one form, the disclosed method further includes the steps of storing information regarding the various monitored conditions of the operational system in a database for analyzing and trending and/or displaying information regarding the various monitored conditions of the operational system of a display for viewing and action by personnel.

The output signals from the plurality of light sensors may be converted into second signals which are understood by the monitoring device.

In a further form, the disclosed method further includes the steps of providing at least one ambient light sensor positioned in proximity to the plurality of light sensors, the at least one ambient light sensor outputting signals indicative of ambient light conditions, and conditioning the output signals from the plurality of light sensors based on the ambient light sensor signals to compensate for ambient light conditions.

The status of the at least one indicator light may be “on” or “off”. However, the status of the at least one indicator light could also be based on how brightly or dimly lit the at least one status indicator light is, depending upon the desired application.

It is an object of the disclosed system and method to provide non-intrusive monitoring of an existing light based indicator system.

It is a further object of the disclosed system and method to provide an external status of an existing light based indicator system to a remote location.

It is yet a further object of the disclosed system and method to provide monitoring of an external light based indicator system with the ability to discriminate between light and dark switching levels in a variety of light conditions.

It is still a further object of the disclosed system and method to provide monitoring of an external light based indicator system allowing for adjustment of the position of the light indictor sensors.

It is an additional object of the disclosed system and method to provide remote monitoring of various conditions of an operational system via the monitoring of an external light based indicator system operatively connected to the operational system.

Other objects, aspects and advantages of the present invention can be obtained from a study of the specification, the drawings, and the appended claims.

### BRIEF DESCRIPTION OF THE DRAWINGS

The present disclosure is explained in the following in greater detail, as an example, with reference to the exemplary embodiments depicted in the following figures, which show:

FIG. 1 is a block diagram of a first embodiment of the inventive system for monitoring information from a light based indicator system;

FIG. 2 shows the signal compensation circuitry implemented with the inventive system for monitoring information from a light based indicator system;

FIG. 3 is a block diagram of an additional embodiment of the inventive system for monitoring information from a light based indicator system;

FIG. 4 is a block diagram of a further embodiment of the inventive system for monitoring information from a light based indicator system;

FIG. 5 is a block diagram illustrating one application of the inventive system for monitoring information from a light based indicator system; and

FIG. 6 is a block diagram of yet a further embodiment of the inventive system for monitoring information from a light based indicator system.

### DETAILED DESCRIPTION OF THE INVENTION

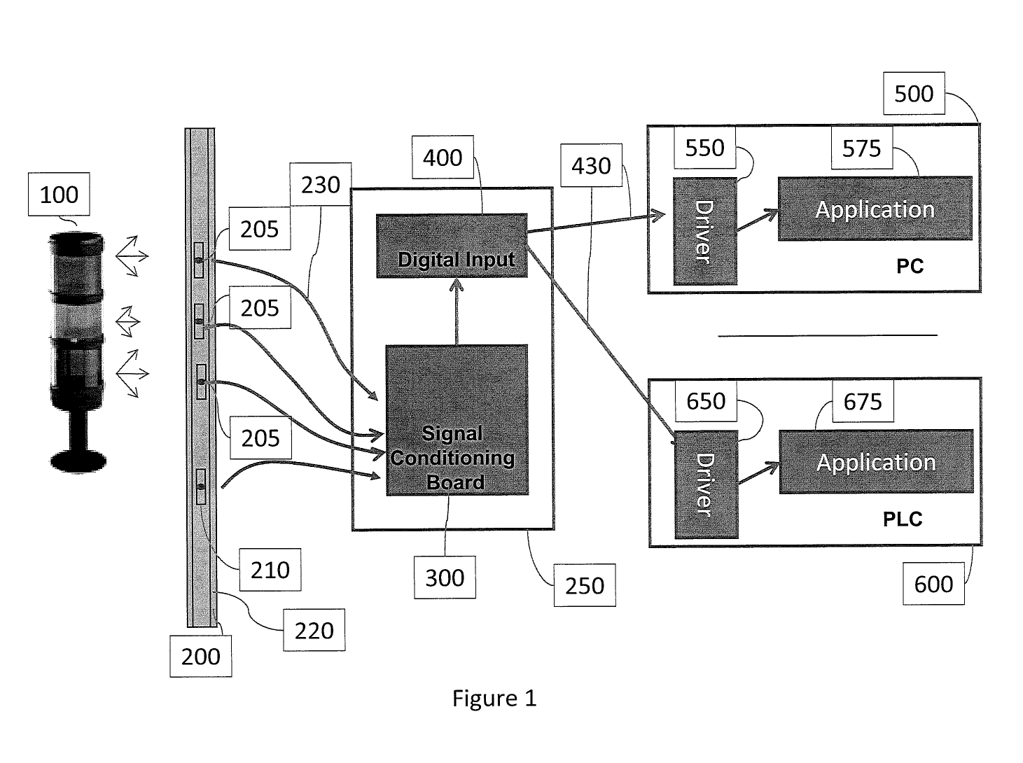

The basic components of the inventive system are shown in FIG. 1, which includes a stack light, or other light based indicator system, 100, a light sensor assembly 200, signal conditioner 250 which includes signal compensation circuitry 300 and a digital input 400, and a monitoring device in the form of a personal computer (“PC”) 500 having a software driver 550 and an application 575, and/or an alternate hardware platform such as a programmable logic controller (“PLC”) 600 having an onboard driver 650 and an application 675. The connection wiring 230 from the light sensor 200 to the signal compensation circuitry 300 and the wiring 430 from the digital input 400 to the PC 500 and/or PLC 600 is also shown in FIG. 1.

The stack lights or light indicators 100 are standard additions to factory equipment to quickly let the operators know how the machinery is operating based on a visual indication of the lights. For example, green typically indicates proper operation, red typically indicates that the machine is halted or at fault, and yellow typically indicates some operational status defined by the tool maker. Of course, other numbers of lights and different colors may be implemented depending on the desired application. Stack lights are usually provided by the equipment maker and their function is designed by the toolmaker to correspond to a well known status. While the disclosed system and method is described herein as applied to a stack light, this is for exemplary purposes only and the disclosed system and method can be applied to other light based indicator systems as will be appreciated by one skilled in the art.

The light sensor assembly 200 includes a plurality of light sensors 205, a mounting rail (base) 220 and the wiring 230. The light sensors 205 can be any of the common photo sensors such as, for example, a photo diode, photo transistor, photo cell or other light sensor. The type of light sensor used is not germane to the inventive system and method. The light sensors 205 may use a variety of power input such as, for example, a 5 volt circuit or a 10 volt circuit. A resistor load (not shown) may be added to the light sensors 205 to help control the output signal.

The mounting rail 220 is a metal support with a track to allow for flexible positioning of the light sensors 205. The light sensors 205 are movably positionable along the length of the mounting rail 220 to be placed at the correct height to be closest to the stack light indicator light to be “viewed”. The light sensors 205 fit in a groove in the mounting rail 220 and can be slid up and down to the desired position. A tight friction fit can hold the light sensors 205 in place or an optional mounting screw can secure the light sensors 205 in place. The mounting rail 220 also has a groove for the wiring 230. The set of connecting wires 230 goes from the light sensors 205 to the signal compensation circuit 300. This wiring is typically coiled to allow for slack so the light sensors 205 can be moved up and down along the mounting rail 220 without requiring special wiring later. While the mounting rail 220 has been described herein as providing a base member for the light sensors 205, any type and configuration of base member may be utilized to support the light sensors 205 without departing from the spirit and scope of the present invention.

As shown in FIG. 1, the light sensors 205 are provided in a one-to-one relationship with the lights to be monitored. However, more than one light sensor 205 can be used to monitor a light, and it may be possible that a given number of lights can be monitored by a lesser number of light sensors 205.

In an optional configuration, the signal compensation circuitry 300 component can be made very small and can mount in or on the mounting rail 220 with one signal compensation circuit 300 per each light sensor 205. Then, the wiring 230 would still be contained in the mounting rail 220, with coils for slack, and would then lead out to the digital input component 400.

The signal compensation circuit component 300 is used to convert the output of the light sensors 210 to a signal which is understood by the digital input 400 of either a personal computer 500 or a programmable logic controller 600. Depending on the type of light sensor 205 used, the input to the signal compensation circuit 300 can be, for example, 0 volts to 5 volts, or 0 volts to 12 volts. Depending on the digital input 400 used, the required range for indicating a light to be “on” can be 0 volts to 2 volts, and the range for indicating a light to be “off” can be 2 volts to 5 volts. Alternately, the ranges could be 0 volts to 10 volts indicates “on”, while 10 volts to 24 volts indicates “off”. As should be appreciated, various ranges could be implemented depending on the desired application and the digital input 400 utilized.

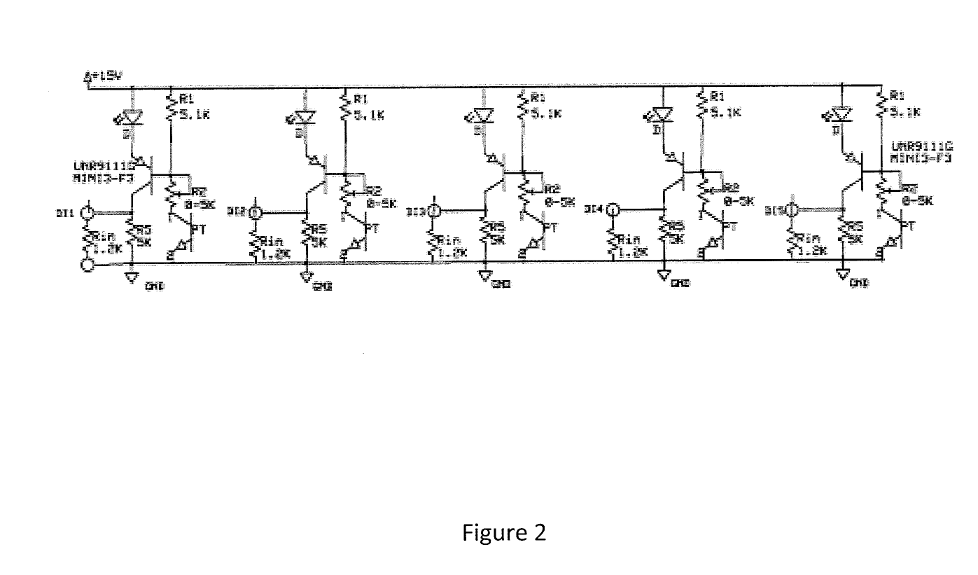

The signal compensation circuit component 300 typically will include a set of transistors and resistors that provide the conversion between the input and output requirements. FIG. 2 shows an example of exemplary conventional circuitry for the compensation circuit 300 (i.e., a signal conditioner). It can be tuned to account for the sensitivity of the light sensors 205 so that correct readings are sent relative to the light being on or off. In some digital input systems 400, the “on” and “off” values are reversed where low is on and high is off. In this case, a transistor is added to reverse the polarity of the “on”.

The signal conditioning circuit component 300 can be passive, as indicated above and shown in FIG. 2, with transistors and resistors matched to the requirements, or it can be active with a microprocessor or microcontroller (not shown) to allow for feedback, comparisons and adjusted output. The polarity adjustment can be passive with a fixed transistor, manually adjustable with a switch setting, or actively modified by a microprocessor or microcontroller, as is known in the art. The voltage range of the signals input by the light sensors 205 can be accepted by either fixed settings of components, manual adjustment control of switch settings, or active modification by a microprocessor or microcontroller. A manual potentiometer could be added for fine tuning of the load in the system to better match the light sensors 205 and light conditions.

Additional light sensors 210 can also be provided to the mounting rail 220 to provide ambient light conditions which can be subtracted from the light readings of the other light sensors 205 to allow the overall system to work in a wide variety of light conditions, including direct sunlight. The compensation circuit 300 receives the signals from the ambient light sensor 210 and conditions the output signals from the light sensors 205 to compensation for ambient light conditions. The compensation circuit 300 provides better control to reduce errors in the readings. Additional conditioning can be considered by optimizing the system for different threshold settings, no false positives, different light frequencies, dim light conditions and other variations.

The digital input 400 accepts the output of the signal compensation circuit 300 and provides a latched on or latched off reading to the PC 500 or the PLC 600 via connection 430, which can be, for example, Ethernet wired, Ethernet wireless, serial (RS-232 or RS485) or cellular.

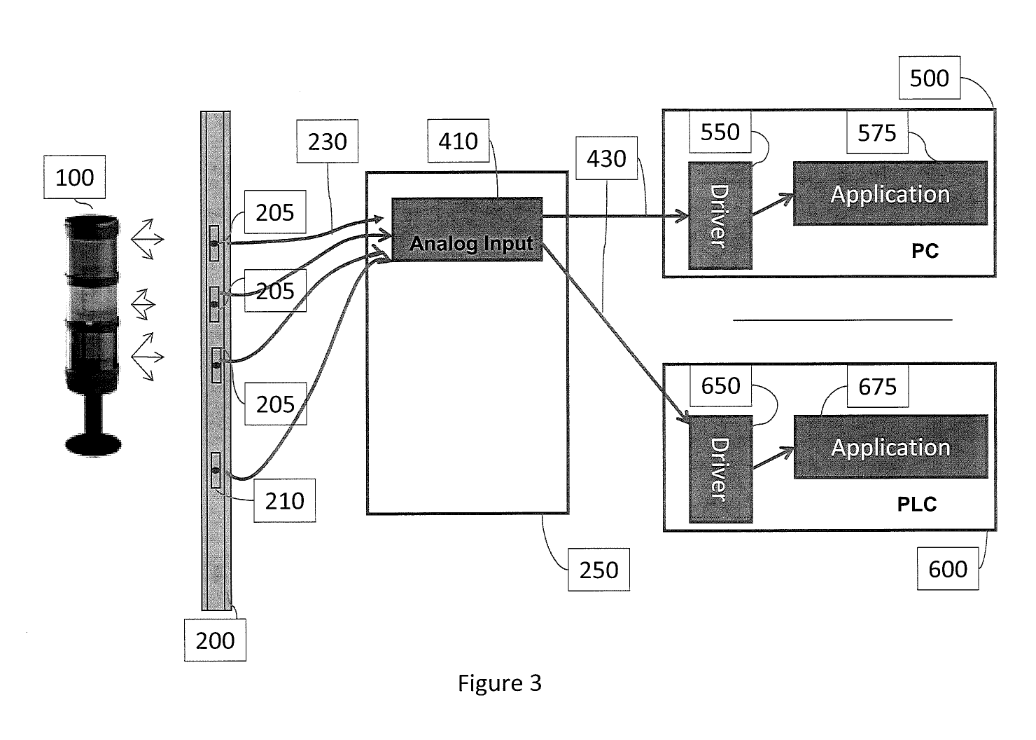

In an optional configuration, shown in FIG. 3, the digital input 400 component could be replaced by an analog input device 410, which would be used to interface to the PC 500 or the PLC 600. In this configuration, the output of the light sensors 205, 210 goes directly to the analog input 410 and then to the PC 500 or the PLC 600. The signals received from the light sensors 205, 210 would then be conditioned by the applications 575 or 675 in the receiving hardware.

In a further optional configuration, the digital input 400 and the signal compensation circuitry component 300 could be combined in a single circuit.

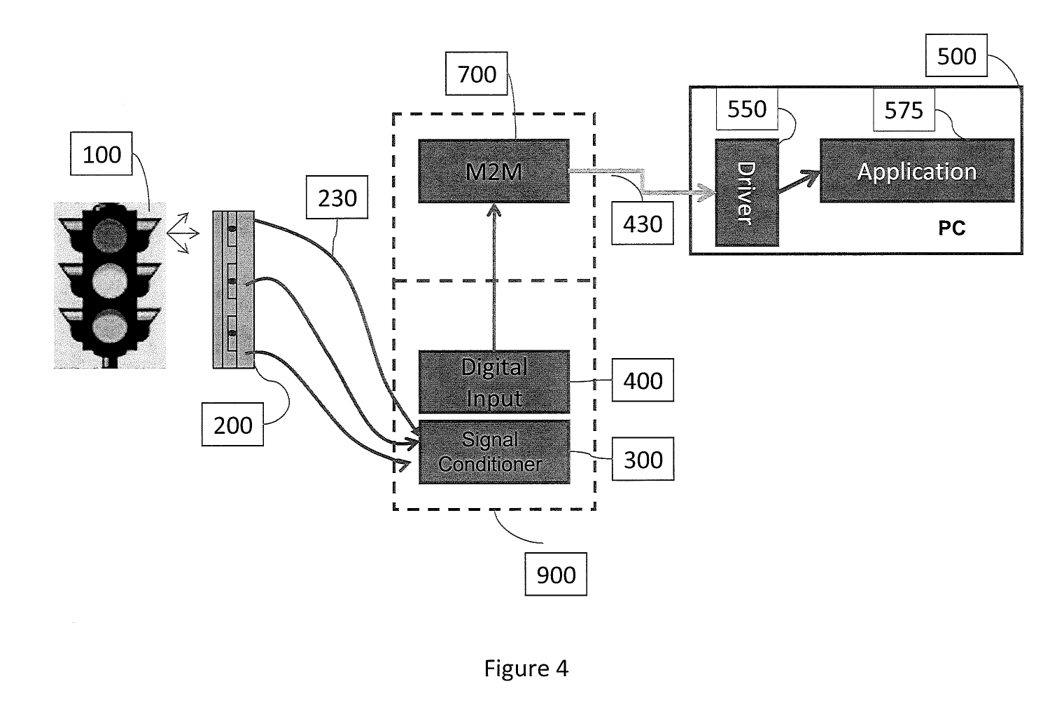

As shown in FIG. 4, the status data can be collected from systems that are in remote areas via non-wired connections. The signal data can be integrated from the digital input 400 to an M2M device 700, which sends the signal via connection 430, which can be a wireless connection, such as, for example, a cellular or Wireless Wi-Fi, instead of an Ethernet connection. The M2M device 700 can be separate from the signal compensation circuitry component 300, or integrated into the same transmission unit 900.

The M2M device 700 can be a low-cost microcontroller based solution using cellular communications interfaces such as, for example, 2G GSM/SMS (Simple Message Services) or 3G GPRS/HSDPA IP oriented modem connections, to allow for the remote sensing of light states globally in any area where cellular network signals are available.

The status of the monitored system or tool is output to an application 575 or 675, such that the system/tool can be monitored remotely from the original light indicator or stack light devices. These applications can incorporate the status data into special applications, standard Supervisory Control and Data Acquisition (“SCADA”) packages, Human Machine Interfaces (“HMI”), or simple web pages for view, for example. The status data can also be placed into a database to collect historical information, calculate uptime percentages, calculate down time, mean time to repair and/or mean time to failure statistics, for example. The application can also perform an analysis on the data. The results of the analysis may be stored in a database or displayed on a dashboard, or displayed in a trending graph, or used to send an alert or an e-mail to a remote system or individual, or otherwise communicated to appropriate personnel.

The light status data collected by the light sensors 205 can alternately be used in applications to execute business logic. This business logic can be implemented at a central computer 500 or PLC 600 or alternately a central server; or the business logic can be implemented in a more local microcontroller or M2M processor 700, for example. Edge logic defined in, for example, a microcontroller would allow events to be recognized which trigger the sending of data from the light sensor 205 to a target message receiver. Alarm conditions or changes of light state could easily be annunciated remotely at any destination in which an application is configured to receive such messages and data. For example, consider the case of a stack light having at least four different colors. A change of light state from green to blue could indicate that “processing” has halted and that a piece of equipment or a work cell has gone into a “setup” mode. A change of state from green to yellow could indicate that “processing” has halted and that a piece of equipment or a work cell has gone into a “stand-by” or “waiting parts” mode. A change of state from green to red could indicate that “processing” has halted and that a piece of equipment or a work cell has gone into a “fault” or “non-operative” mode. Lack of signal changes over a set period of time could trigger an alarm to indicate possible failure of the signaling apparatus and/or bulb/LED failures. The changes of status and/or alarm events could be sent to, for example, the original equipment manufacturer (“OEM”) as an event or an alert so that they can have up to date operational information.

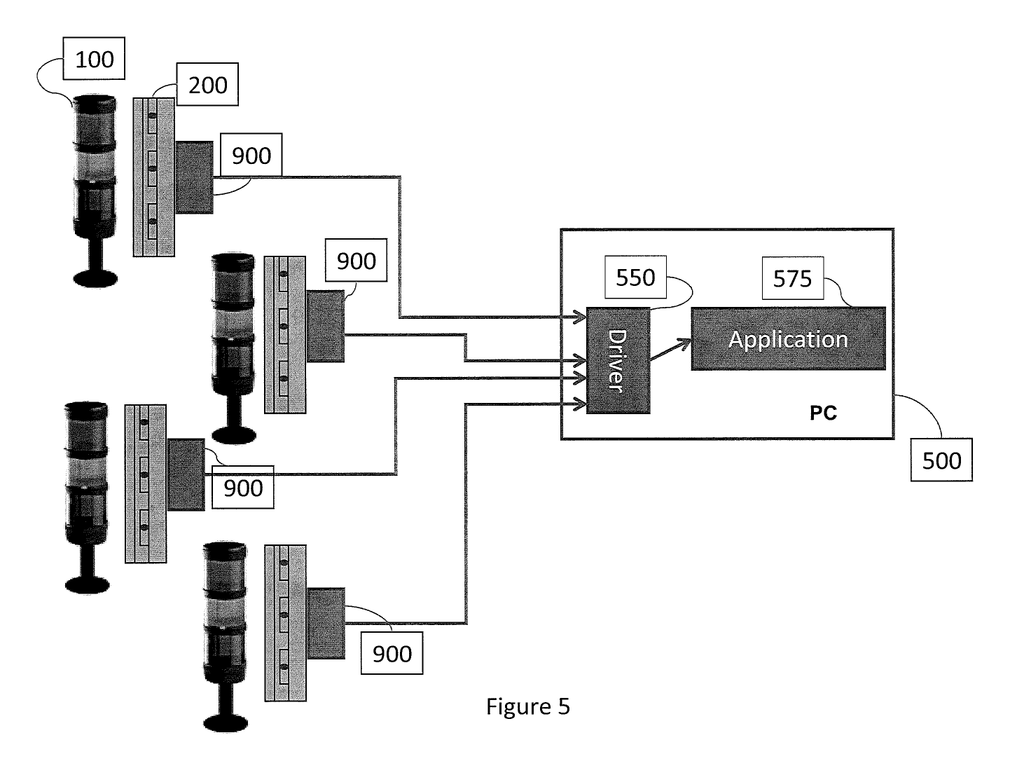

A large benefit of the disclosed system and method is the ability to aggregate the status of many indicator lights into a single location or dashboard. As shown in FIG. 5, many stack lights 100 can be monitored by a light sensor assemblies 200 and transmission units 900. The transmission unit 900 is the combination of the components for easy wiring. This combination is one or more of: signal compensation circuit 300, digital input 400, and optional M2M 700 devices. Each of the light sensor assemblies 200 monitors its respective stack light 100 in a manner as previously described, and provides its resultant data to a single monitoring device, such as the PC 500. By providing this aggregate application, one person or application 575 or 675 can utilize data from many machines to make decisions and calculations. The data may be displayed on a system in the local area network of the original tools/lights, or it may go to an internet server or to an alternate network for monitoring. Data presented on an internet server may be easily viewed by local and remote personnel.

Another key benefit to the disclosed system and method is the ability to link the light sensor status information to other sensor information and create business logic based on the aggregated information. Using the Manufacturing-to-Enterprise connectivity software described in U.S. Pat. No. 7,904,181, the user can create business logic that uses the light sensor data and does analysis and then actions based on the data. For example, when the yellow light is on, an alert can be sent to the tool maintenance cell phone. When the red light is on, and if a machine sensor shows the presence of a part, two actions can be taken: 1) the alert is sent to the tool operator; and 2) an alert is sent to the tool maintenance cell phone. A further optional application of the present invention would be to sense the status (outage) of traffic signals and railroad signals. Rather than relying on a driver of an automobile to report the outage of a traffic signal or railway crossing signal, an external sensor can be used to relay light status to a central controller for review and to be scheduled for repair. In this regard, an alternate application could be to write the business logic for railroad lights by gathering data from a sensor indicating the presence of a train and compare that data to the light sensor readings to verify the warning lights are on when they are required to be for safety reasons. This software can execute the business logic at the central location or within an edge processing unit like, for example, the transmission unit 900.

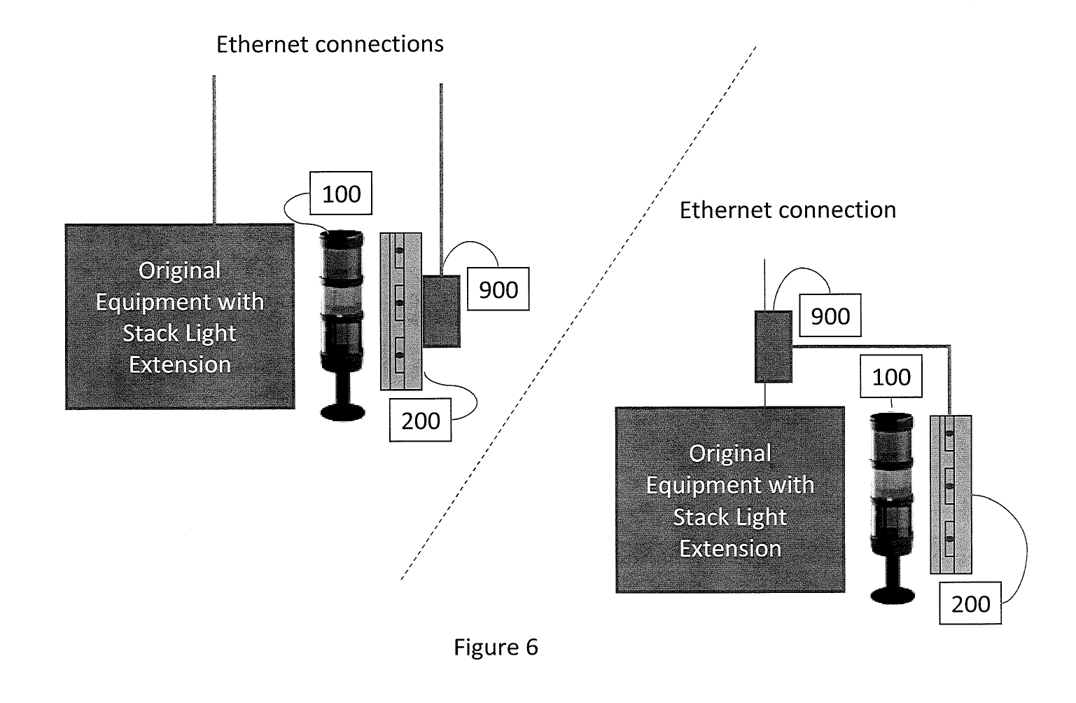

FIG. 6 shows an optional configuration for the stack light sensor system in a plant where there is a network switch within the transmission unit 900, so that no new Ethernet drops would be required in the factory to allow this system to run in parallel with the equipment. As shown in FIG. 6, the transmission unit may either be provided on the mounting rail 220 or separate from it.

The disclosed system may be powered, for example, via solar rechargeable battery, simple battery or AC power. The data may be relayed, for example, via Ethernet, Wi-Fi, Bluetooth, cellular, or other similar means. The data that is displayed may be in a central location or several remote stations. The data may also be stored in a database to create history trends for the equipment. The data may be displayed on a system in the local area network of the original tools/lights, or it may be sent to an Internet server or to an alternate network for remote monitoring and/or analysis. Other sensors can be added to the disclosed system to provide a separate control system. These sensors may include, but are not limited to, thermal, vibration, gas, parts counters, weight, current, flow, humidity sensors and cameras with barcode or shape recognition, and other similar sensors. The entire set of sensors and control boards can be housed, for example, in a NEMA enclosure for use in, for example, the food industry or industrial plants with harsh and/or dangerous environments. A circuit board and software may be used to condition the output signal of the stack light sensor or any other systems to allow for the control and calibration of the type of data that is reported.

The disclosed system and method feeds, automatically or otherwise, the results of the light sensor array into a signal processing system, which could be provided on the local board or could be located at a central processing location, for analysis. The results of the analysis may be stored in a database or displayed on a dashboard, or displayed in a trending graph, or used to send an alert or an e-mail to a remote system or individual.

While the present invention has described herein with particular reference to the drawings, it should be understood that various modifications could be made without departing from the spirit and scope of the present invention. It will be apparent to those skilled in the art that numerous modifications and variations of the described examples and embodiments are possible in light of the overall teachings of the disclosure. The disclosed examples and embodiments are presented for purposes of illustration only and are not meant to limit the scope of the invention in any way. Therefore, it is the intent to cover all such modifications and alternate embodiments as may come within the true scope of this invention, which is to be given the full breadth thereof. Additionally, the disclosure of a range of values is a disclosure of every numerical value within that range.

We claim:

1. A system for monitoring status information from a light based indicator system, the system comprising:
at least one light sensor positioned adjacent to an existing light indicator system, the existing light based indicator system having at least one indicator light to be monitored; and
a monitoring device at a location remote from the existing light based indicator system, the monitoring device receiving signals from the at least one light sensor indicative of a status of the at least one indicator light.

2. The system of claim 1, wherein the monitoring device stores information regarding the status of the at least one indicator light in a database as status data.

3. The system of claim 1, wherein the monitoring device displays information regarding the status of the at least one indicator light on a display as status data.

4. The system of claim 1, wherein the monitoring device comprises a personal computer (“PC”) or a programmable logic controller (“PLC”).

5. The system of claim 1, wherein the status of the at least one indicator light is indicative of a condition of a production system operatively connected to the light based indicator system, and wherein the monitoring device monitors conditions of the production system via the status of the at least one indicator light.

6. The system of claim 1, further comprising a signal conditioning device receiving the signals from the at least one light sensor indicative of the status of the at least one indicator light and converting the received signals into second signals which are understood by the monitoring device.

7. The system of claim 1, wherein the status of the at least one indicator light is “on” or “off”.

8. The system of claim 1, wherein the status of the at least one indicator light is provided as an input to business logic, alone or in combination with other sensor data, to trigger events and/or alerts.

9. The system of claim 1, further comprising:
an ambient light sensor positioned in proximity to the at least one light sensor; and
a compensation circuit receiving (a) signals from the ambient light sensor indicative of ambient light conditions, and (b) signals from the at least one light sensor indicative of the status of the at least one indicator light,
wherein the compensation circuit conditions the at least one light sensor signals based on the ambient light sensor signals to compensate for ambient light conditions.

10. The system of claim 1, wherein the at least one light sensor is movably attached to a base member mountable adjacent to the existing light based indicator system.

11. The system of claim 1, wherein the existing light based indicator system comprises stack lights, status lights, traffic lights or safety lights.

12. A system for monitoring status information from a light based indicator system having a plurality of indicator lights to be monitored, the system comprising:
a plurality of light sensors positioned adjacent the plurality of indicator lights, the plurality of light sensors outputting signals indicative of a status of each of the plurality of indicator lights, wherein the status of each of the plurality of indicator lights is indicative of various conditions of an operational system to which the light based indicator system is operatively connected; and
a monitoring device at a location remote from operational system and the existing light based indicator system, the monitoring device receiving the output signals from the plurality of light sensors and monitoring the various conditions of the operational system via the status of each of the plurality of indicator lights.

13. The system of claim 12, wherein the monitoring device stores information regarding the various monitored conditions of the operational system in a database for analyzing and trending.

14. The system of claim 12, wherein the monitoring device displays information regarding the various monitored conditions of the operational system on a display for viewing and action by personnel.

15. The system of claim 12, wherein the monitoring device comprises a personal computer (“PC”) or a programmable logic controller (“PLC”).

16. The system of claim 12, further comprising a signal conditioning device receiving the output signals from the plurality of light sensors and converting the received signals into second signals which are understood by the monitoring device.

17. The system of claim 12, wherein the status of each of the plurality of indicator lights is “on” or “off”.

18. The system of claim 12, further comprising:
at least one ambient light sensor positioned in proximity to the plurality of light sensors; and
a compensation circuit receiving (a) signals from the at least one ambient light sensor indicative of ambient light conditions, and (b) the output signals from the plurality of light sensors,
wherein the compensation circuit conditions the output signals from the plurality of light sensors based on the ambient light sensor signals to compensate for ambient light conditions.

19. The system of claim 12, wherein the plurality of light sensors are movably attached to a base member mountable adjacent to the existing light based indicator system.

20. The system of claim 12, wherein the plurality of light sensors are provided in a one-to-one relationship with the plurality of indicator lights, such that one light sensor monitors the status of one indicator light.

21. The system of claim 12, wherein the existing light based indicator system comprises stack lights, status lights, traffic lights or safety lights.

22. A method of monitoring status information from a light based indicator system having a plurality of indicator lights to be monitored, the method comprising the steps of:
providing a plurality of light sensors positioned adjacent the plurality of indicator lights, the plurality of light sensors outputting signals indicative of a status of each of the plurality of indicator lights, wherein the status of each of the plurality of indicator lights is indicative of various conditions of an operational system to which the light based indicator system is operatively connected;
transmitting the output signals from the plurality of light sensors to a monitoring device at a location remote from operational system and the existing light based indicator system; and
monitoring the various conditions of the operational system via the status of each of the plurality of indicator lights at the remote location.

23. The method of claim 22, further comprising the step of storing information regarding the various monitored conditions of the operational system in a database for analyzing and trending.

24. The method of claim 22, further comprising the step of displaying information regarding the various monitored conditions of the operational system of a display for viewing and action by personnel.

25. The method of claim 22, further comprising the step of converting the output signals from the plurality of light sensors into second signals which are understood by the monitoring device.

26. The method of claim 22, further comprising the steps of:
providing at least one ambient light sensor positioned in proximity to the plurality of light sensors, the at least one ambient light sensor outputting signals indicative of ambient light conditions; and
conditioning the output signals from the plurality of light sensors based on the ambient light sensor signals to compensate for ambient light conditions.

27. The method of claim 22, wherein the status of each of the plurality of indicator lights is “on” or “off”.

28. The method of claim 22, wherein the existing light based indicator system comprises stack lights, status lights, traffic lights or safety lights.
